(19) United States
(12) Patent Application Publication
(10) Pub. No.: US 2024/0243305 A1
(43) Pub. Date: Jul. 18, 2024

(54) A COOLING ARRANGEMENT FOR A FUEL CELL ELECTRIC VEHICLE

(71) Applicant: Volvo Truck Corporation, GÖTEBORG (SE)

(72) Inventor: Sigurd SONDEREGGER, Askim (SE)

(21) Appl. No.: 18/565,116

(22) PCT Filed: Jun. 3, 2021
(86) PCT No.: PCT/EP2021/064932

§ 371 Date: Nov. 29, 2023

(51) Int. Cl. H01M 8/04007; H01M 8/04029; H01M 8/04082

(52) U.S. Cl. CPC H01M 8/04074; H01M 8/04029; H01M 8/04216; H01M 2250/20

(57) ABSTRACT

A cooling arrangement for a fuel cell electric vehicle includes a hydrogen tank including a metal enveloping wall, a heat exchanger comprising a metal part with at least one internal coolant channel for conducting a coolant to fuel cells of the vehicle, wherein the metal enveloping wall of the hydrogen tank has at least one planar exterior wall portion, wherein the metal part of the heat exchanger is attached to the planar exterior wall portion of the hydrogen tank to form a metal-to-metal contact for transferring heat from the coolant, via the metal part of the heat exchanger, to the metal enveloping wall of the hydrogen tank. A fuel cell electric vehicle including such a cooling arrangement is also disclosed.

### CROSS REFERENCE TO RELATED APPLICATIONS

This application is a 35 U.S.C. § 371 national stage application of PCT International Application No. PCT/EP2021/064932 filed on Jun. 3, 2021, the disclosure and content of which is incorporated by reference herein in its entirety.

### TECHNICAL FIELD

The present disclosure relates to a cooling arrangement for a fuel cell electric vehicle. The present disclosure also relates to a fuel cell electric vehicle comprising such a cooling arrangement.

The disclosed subject matter can be applied in heavy-duty vehicles, such as trucks, buses and construction equipment. Although the present disclosure will be described with respect to a truck, the present disclosure is not restricted to this particular vehicle, but may also be used in other vehicles such as cars.

### BACKGROUND

The vehicle industry is striving to reduce CO₂ emissions. Various alternatives to diesel and gasoline have been developed for energizing the vehicles. One such alternative is battery electric vehicles (BEV). Another alternative is the use of hydrogen gas. The chemical energy of the hydrogen may, for example, be converted into mechanical energy in an internal combustion engine or into electric energy in fuel cells, in order to propel the vehicle.

Fuel cell electric vehicles (FCEV) have a large cooling need, especially as the maximum allowed coolant temperatures are normally lower than on trucks with internal combustion engine. Normally there is provided a heat exchanger with a coolant channel which conduct a coolant to the fuel cells. Heat energy is transferred from the fuel cells to the coolant which is returned to the heat exchanger where it is cooled by means of air flow before it once again flows to the fuel cells. However, air flow cooling is not very efficient. It would thus be desirable to improve the cooling of the coolant.

### SUMMARY

An object of the present disclosure is to provide a cooling arrangement which mitigates the drawbacks of the prior art. This and other objects, which will become apparent in the following, are achieved by a cooling arrangement according to claim 1.

The present disclosure is based on the realization that metal has a better heat conductivity than air and that the heat exchanger and thus the coolant may more efficiently be cooled by providing a large metal interface to the heat exchanger. In particular, the inventor has realized, that a hydrogen tank of the FCEV is normally made of metal and of considerable size and weight, and is therefore a good candidate to provide such a metal interface for transferring heat energy away from the heat exchanger and thus away from the coolant. In particular, by making at least one exterior metal surface of the hydrogen tank planar, the heat exchanger may be effectively attached to provide a good metal-to-metal contact for efficient heat energy transfer.

Thus, according to a first aspect of the present disclosure there is provided a cooling arrangement for a fuel cell electric vehicle (FCEV). The cooling arrangement comprises:
a hydrogen tank comprising a metal enveloping wall,
a heat exchanger comprising a metal part with at least one internal coolant channel for conducting a coolant to fuel cells of the vehicle,
   wherein the metal enveloping wall of the hydrogen tank has at least one planar exterior wall portion, wherein the metal part of the heat exchanger is attached to said planar exterior wall portion of the hydrogen tank to form a metal-to-metal contact for transferring heat from the coolant, via the metal part of the heat exchanger, to the metal enveloping wall of the hydrogen tank.

By the provision of a cooling arrangement having a planar metal-to-metal contact between the heat exchanger and the hydrogen tank a large surface area of the heat exchanger may be used for transferring heat energy away from the coolant. Furthermore, by using the hydrogen tank which is needed for providing hydrogen to the fuel cells, there is no need for any extra metallic cooling structure. The hydrogen tank will thus have a dual functionality, on the one hand functioning as a source of hydrogen, and on the other hand functioning as a means to cool the coolant. Since the hydrogen tank is of a relatively large size and weight (e.g., between 100 and 800 kg) the hydrogen inside the tank will not be heated too much even if a large part of the enveloping surface of the hydrogen tank is covered by the heat exchanger.

It should be understood that the metal enveloping wall does not necessarily need to have planar surfaces only. One planar surface for providing the metal-to-metal contact may suffice. For example, the rest of the enveloping wall, or some portions thereof, may be rounded. Nevertheless, in at least some exemplary embodiments the several or even all sides of the enveloping wall may suitably be planar. This is at least partly reflected in the following exemplary embodiment.

According to at least one exemplary embodiment, the hydrogen tank is cuboid. This is advantageous since more than one planar surface may be used for contacting the heat exchanger. For example, in at least some exemplary embodiments, the metal part of the heat exchanger covers all six sides of the hydrogen tank to form metal-to-metal contact on all six sides thereof. In other exemplary embodiments, a plurality of individual heat exchangers may be attached to a respective planar exterior wall portion of the metal enveloping wall of the hydrogen tank.

It should be noted that the internal design of the hydrogen tanks does not form part of the present inventive concept. Rather, it is the outer contour of the hydrogen tank that is of interest for the general inventive concept for providing a satisfactory heat energy transfer capability. For example, although the outer contour of a hydrogen tank may be cuboid or may have a cuboid portion, the hydrogen tank may for example be provided with an interior wall having a rounded shape.

As implied above, the hydrogen tank may in some exemplary embodiments have a cuboid portion. For instance, if the hydrogen tank is intended to be install laterally of a chassis frame rail, then the hydrogen tank may suitably be cuboid, similarly to a battery pack. This may be advantageous as the same installation equipment may then be used as for a battery pack, and the same supporting structure provided at the chassis may be used for receiving battery packs and hydrogen tanks. Thus, the manufacturing process in a factory may be facilitated and easily adapted to individual vehicles by providing a modular system of battery packs and hydrogen tanks. Furthermore, in order to take advantage of the available volume, for example, underneath the frame rail, it would be conceivable to have a smaller portion of the hydrogen tank projecting from the cuboid portion such that the smaller portion fits underneath the frame rail. Thus, in a general sense, according to at least one exemplary embodiment the hydrogen tank has a rectangular cross-section. The rectangular cross-section is of course present for a cuboid hydrogen tank, but it may also be present for other shapes, such as the above exemplified hydrogen tank in which a portion of the tank is cuboid.

It should be noted that the rectangular cross-section discussed herein encompasses the specific case of a rectangle having equal sized sides, i.e., a square cross-section, but also other rectangular shapes in which one of the pairs of opposing sides has different length compared to the other pair of opposing sides.

The different direction of a vehicle can normally be defined as follows. The longitudinal direction is the direction in which the vehicle drives when the wheels are not turning. The longitudinal direction coincides or is parallel with what is normally referred to as the roll axis of the vehicle. The vertical direction of the vehicle is perpendicular to the ground on which the vehicle stands. In other words, a vertical direction coincides or is parallel with what is normally referred to as the yaw axis of the vehicle. The width or lateral direction of the vehicle coincides or is parallel with the pitch axis of the vehicle, and is thus perpendicular to the previous two directions. For various reasons, such as the locations of tube or pipe connectors of the hydrogen tank, the hydrogen tank will normally have a designated orientation relative to the vehicle. For instance, when manufacturing the vehicle in a factory the hydrogen tank will be mounted to the chassis of the vehicle in a predefined orientation. This is at least partly reflected in some of the following exemplary embodiments.

According to at least one exemplary embodiment, the hydrogen tank is configured to be mounted to the vehicle so that said planar exterior wall portion to which the metal part of the heat exchanger is attached defines a vertical plane. Thus, said planar exterior wall portion extends parallel to the yaw axis. Such a vertical plane may normally be relatively easily accessible and thus facilitates the attachment of heat exchanger. For instance, in the case of a truck, the hydrogen tank may be provided laterally of a frame rail in which case the vertical plane may suitably face away from the roll axis of the vehicle. In other installations, the hydrogen tank may be provided behind the cab of the truck, in which case the vertical plane may towards the rear of the vehicle or face laterally, either of which being easily accessible.

According to at least one exemplary embodiment, the hydrogen tank has an inboard side configured to face towards the central longitudinal axis (i.e., the roll axis) of the vehicle and an outboard side configured to face away from the central longitudinal axis of the vehicle, wherein said planar exterior wall portion is located on the outboard side, wherein the attached heat exchanger forms a collision protection structure for protecting the hydrogen tank. By having said planar exterior wall portion facing laterally away from the vehicle and providing the heat exchanger as an outer cover, the heat exchanger will receive the impact if subjected to a side collision. Thus, the heat exchanger may absorb some of the collision force and become deformed before the remaining force affects the hydrogen tank which contains highly flammable hydrogen.

According to at least one exemplary embodiment, the hydrogen tank is configured to be mounted to a vehicle so that said planar exterior wall portion to which the metal part of the heat exchanger is attached defines a horizontal plane. Such a horizontal plane will extend in parallel with the pitch axis and the roll axis. This too provides protection to a certain extent.

According to at least one exemplary embodiment, the hydrogen tank has a lower side configured to face towards the ground on which the vehicle stands and an upper side configured to face away from the ground, wherein said planar exterior wall portion is located on the upper side, wherein the attached heat exchanger forms a walking platform enabling a person to stand on the heat exchanger without touching the hydrogen tank. This may be advantageous for tractor vehicles, wherein the driver may use the heat exchanger to step on as a catwalk, during assembly/disassembly or trailer connections.

As already mentioned, the heat metal-to metal contact and the heat transfer interface are not necessarily limited to one plane. For instance, according to one exemplary embodiment, the metal enveloping wall of the heat exchanger has at least two planar exterior wall portions which extend perpendicularly to each other, wherein the metal part of the heat exchanger has an L-shaped cross-section such that metal-to-metal contact is formed with both of said two planar exterior wall portions. Thus, by utilizing a larger surface area for metal-to-metal contact, the cooling of the coolant running through the heat exchanger may be further improved. Said L-shape may, for instance, be formed by one vertical planar wall portion and one horizontal wall portion. However, in other exemplary embodiments, the L-shape may be formed by two vertical planar wall portions, such as one facing laterally and one facing forwardly or rearwardly.

Although the general inventive concept is based on making use of the metal-to-metal contact by providing contact between a planar wall portion of the hydrogen tank and the metal part of the heat exchanger, it is conceivable to combine this with air flow cooling. This is at least partly reflected in at least one exemplary embodiment, according to which the heat exchanger is provided with a plurality of fins for air cooling of the heat exchanger.

According to at least one exemplary embodiment, the fins are provided on a side of the heat exchanger which is opposite to the side that contacts the planar exterior wall portion of the hydrogen tank. This will often provide a good location for air flow across the fins.

The fins may suitable be designed such that they provide a walking surface, such as mentioned above. By providing the fins at an appropriate distance relative to each other, they will not only present an area for receiving air flow but, but also provide a rough surface to reduce the risk of a driver slipping when stepping onto the heat exchanger.

According to a second aspect of the present disclosure there is provided a fuel cell electric vehicle (FCEV) comprising fuel cells and a cooling arrangement according to the first aspect, including any embodiment thereof.

The advantages of the FCEV of the second aspect of the present disclosure largely corresponds to the advantages of the cooling arrangement of the first aspect, including any embodiment thereof.

Generally, all terms used in the claims are to be interpreted according to their ordinary meaning in the technical field, unless explicitly defined otherwise herein. All references to “a/an/the element, apparatus, component, means, etc.” are to be interpreted openly as referring to at least one instance of the element, apparatus, component, means, etc., unless explicitly stated otherwise. Further features of, and advantages with, the present disclosure will become apparent when studying the appended claims and the following description. The skilled person realizes that different features of the present disclosure may be combined to create embodiments other than those described in the following, without departing from the scope of the present disclosure.

### BRIEF DESCRIPTION OF THE DRAWINGS

With reference to the appended drawings, below follows a more detailed description of embodiments of the present disclosure cited as examples.

In the drawings:

FIG. 1 illustrates schematically a vehicle for which at least some exemplary embodiments of the present disclosure may be implemented.

FIG. 2 illustrates schematically a cooling arrangement according to at least one exemplary embodiment of the present disclosure.

FIG. 3 illustrates schematically a cross-sectional view of the cooling arrangement of FIG. 2.

FIGS. 4-7 illustrates schematically cross-sectional views of cooling arrangements according to at least some other exemplary embodiments of the present disclosure.

### DETAILED DESCRIPTION

The present disclosure will now be described more fully hereinafter with reference to the accompanying drawings, in which certain aspects of the present disclosure are shown. The present disclosure may, however, be embodied in many different forms and should not be construed as limited to the embodiments and aspects set forth herein; rather, the embodiments are provided by way of example so that this disclosure will be thorough and complete, and will fully convey the scope of the present disclosure to those skilled in the art. Accordingly, it is to be understood that the present disclosure is not limited to the embodiments described herein and illustrated in the drawings; rather, the skilled person will recognize that many changes and modifications may be made within the scope of the appended claims. Like reference numerals refer to like elements throughout the description.

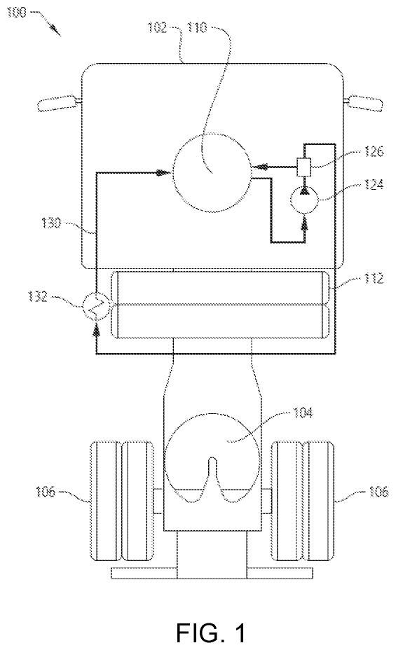

FIG. 1 illustrates schematically a vehicle 100 for which at least some exemplary embodiments of the present disclosure may be implemented. Although the vehicle 100 is illustrated in the form of a truck, other types of vehicles, such as busses, construction equipment, trailers, passenger cars or even boats may be provided in accordance with the present disclosure. The truck (vehicle 100) comprises a cab 102 in which a driver may operate the vehicle 100. The vehicle 100 comprises an energy conversion system 110 which includes a stack of fuel cells. The illustration is made relative to a schematic outline of certain parts of a truck, however, it should be understood that the specific location of the components may be placed differently than in the exemplary illustration. In the illustration the cab 102 of the truck, a connector 104 for towing a trailer and a pair of rear wheels 106 of the truck have been schematically indicated. The fuel cells 110 may be provided at the cab 102, for example under the cab 102. Behind the cab 102, there are provided hydrogen tanks 112 for storing hydrogen gas which may be supplied to the fuel cells 110. The hydrogen tanks 112 are merely illustrated schematically and only two are shown. However, it should be understood that the vehicle 100 may have more hydrogen tanks, or fewer. Although not illustrated, the hydrogen tanks 112 may suitably be held by a rack attached to the chassis, or by any other suitable support structure.

The vehicle 100 further comprises a heat exchanger 132 and a cooling passage 130 for circulating a coolant, i.e., a cooling liquid, such as for example water. The cooling passage 130 extends from the heat exchanger 132 and passes along the stack of fuel cells 110 for transporting heat away from the stack of fuel cells 110.

A pump 124 is provided to pump coolant that has taken up heat from the stack of fuel cells 110. Downstream of the pump 124 there may optionally be provided a thermostat 126 which senses the temperature of the coolant in the conduit and if the temperature is above a predefined value the coolant is led back to the heat exchanger 132 to be cooled down before returning to the stack of fuel cells 110. If the thermostat 126 determines that the temperature of the coolant is still low enough, it may be returned to the stack of fuel cells 110 without being led through the heat exchanger 132. At least one of the hydrogen tanks 112 and the heat exchanger 132 form part of a cooling arrangement according to the general inventive concept. Their interconnection will now be discussed in more detail with reference to the other drawing figures.

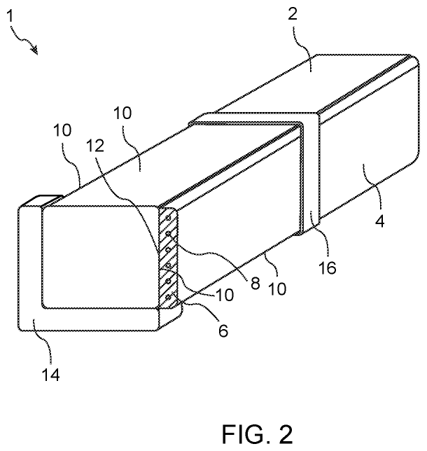

FIG. 2 illustrates schematically a cooling arrangement 1 according to at least one exemplary embodiment of the present disclosure. The cooling arrangement comprises a hydrogen tank 2 comprising a metal enveloping wall. Thus, the hydrogen tank 2 in FIG. 2 may for example represent one of the schematically indicated hydrogen tanks 112 in FIG. 1. The cooling arrangement in FIG. 2 also comprises a heat exchanger 4, which may thus be used as the schematically indicated heat exchanger 132 in FIG. 1. The heat exchanger 4 of FIG. 2 comprises a metal part 6 with internal coolant channel(s) 8 for conducting coolant to fuel cells of the vehicle (e.g., the coolant channel(s) 8 may deliver the coolant to the cooling passage 130 in the vehicle 100 of FIG. 1). The heat exchanger 4 may have one or more inlets and one or more outlets (not shown in FIG. 2). The at least one coolant channel 8 fluidly connects the inlet(s) and the outlet(s). The heat exchanger 4 may, for instance, comprise a single coolant channel 8, lingering back and forth through the metal part 6 to cover a larger area of the metal part 6, or it may comprise two or more separate coolant channels (which may or may not linger back and forth).

The metal enveloping wall of the hydrogen tank 2 has at least one planar exterior wall portion 10. As illustrated in FIG. 2 in the present exemplary embodiment, there are several planar exterior wall portions 10 as the hydrogen tank 2 is cuboid. Thus, in the present exemplary embodiment, the hydrogen tank 2 has a rectangular cross-section. However, as mentioned previously, other shapes may be combined with the at least one planar exterior wall portion 10.

The metal part 6 of the heat exchanger 4 is attached to said planar exterior wall portion 10 of the hydrogen tank 2 to form a metal-to-metal contact for transferring heat from the coolant, via the metal part 8 of the heat exchanger 4, to the metal enveloping wall of the hydrogen tank 2. In other words, as can be seen in FIG. 2, the hydrogen tank 2 and the heat exchanger 4 may share a planar interface 12, as the contacting part of the heat exchanger 4 is suitably also planar. In the illustrated example, the planar interface 12 defines a vertical plane, however, as will be understood from some of the other drawing figures, the planar interface may be arranged in a different plane, such as extending in a horizontal plane.

As schematically illustrated in FIG. 2, the hydrogen tank 2 and optionally also the heat exchanger 4 may rest on a bracket 14 or any other suitable support structure, such as a rack, a cage, a box, etc. The bracket 14 may suitably be fixed to the chassis of the vehicle, such as to a longitudinal frame rail of the chassis. It should be noted, however, that other locations on the vehicle are also conceivable. As schematically illustrated in FIG. 2 the cooling arrangement 1 may suitably include attachment means, for attaching the heat exchanger 4 to the hydrogen tank 2. In this exemplary embodiment, a strap 16 is illustrated as an example of an attachment means. However, other numbers and types of attachment means, such as bracket, screws, bolts, etc., and combinations thereof, are also conceivable.

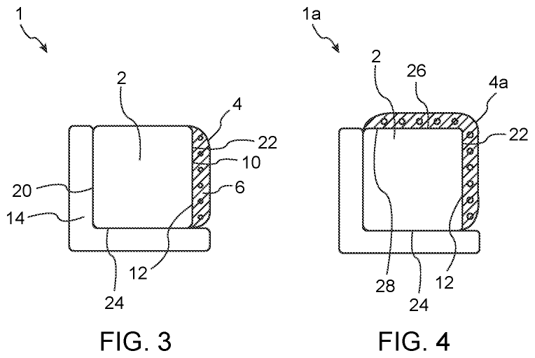

FIG. 3 illustrates schematically a cross-sectional view of the cooling arrangement 1 of FIG. 2. As can be seen in FIG. 3, in some exemplary embodiments the hydrogen tank 2 is configured to be mounted to the vehicle so that said planar exterior wall portion 10 to which the metal part 6 of the heat exchanger 4 is attached defines a vertical plane. The hydrogen tank 2 may have an inboard side 20 configured to face towards the central longitudinal axis of the vehicle and an outboard side 22 configured to face away from the central longitudinal axis of the vehicle. In the illustrated exemplary embodiment, the planar exterior wall portion 10 and thus the interface 12 with the heat exchanger 4 defining the vertical plane, is located on the outboard side 22. The inboard side 20 (and the lower side 24) of the hydrogen tank 2 may in this case be in contact with the bracket 14. The attached heat exchanger 4, being provided on the outboard side 22, may suitably form a collision protection structure for protecting the hydrogen tank 2. This may in particular be useful in the event of a side collision.

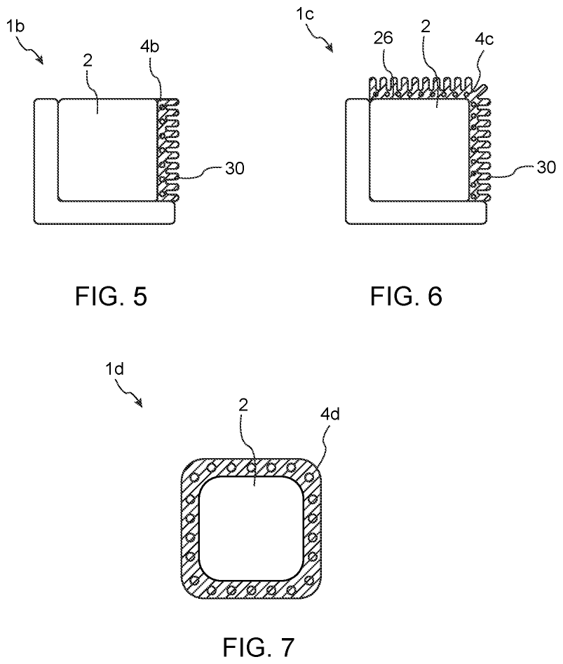

FIGS. 4-7 illustrates schematically cross-sectional views of cooling arrangements 1a-1d according to at least some other exemplary embodiments of the present disclosure.

FIG. 4 illustrates an exemplary embodiment of a cooling arrangement 1a in which the heat exchanger 4a has a substantially L-shaped cross section, extending not only along the outboard side 22 of the hydrogen tank 2, but also along the upper side 26 of the hydrogen tank 2. Thus, the two components, form not only an interface 12 defining a vertical plane, but also an interface 28 defining a horizontal plane. In other words, the metal enveloping wall of the heat exchanger 2 may have at least two planar exterior wall portions which extend perpendicularly to each other, wherein the metal part of the heat exchanger has an L-shaped cross section such that metal-to-metal contact is formed with both of said two planar exterior wall portions.

It should, be understood that in some exemplary embodiments, the heat exchanger may be attached exclusively to the upper side 26 (or lower side 24) of the hydrogen tank 2, and the interface 12 defining the vertical plane may be omitted in such embodiments. Thus, in a general sense, according to at least some exemplary embodiments, the hydrogen tank is configured to be mounted to a vehicle so that said planar exterior wall portion to which the metal part of the heat exchanger is attached defines a horizontal plane. Since the heat exchanger 4a in FIG. 4 covers the upper side 26 of the hydrogen tank 2, it may be used as a walking platform enabling a person to stand on the heat exchanger 4a without touching the hydrogen tank 2.

The exemplary embodiments of the cooling arrangements 1b and 1c in FIGS. 5 and 6 substantially correspond to the exemplary embodiments of the FIGS. 3 and 4, respectively, however, with the addition of fins 30. Thus, FIGS. 5 and 6 illustrate that in at least some exemplary embodiments, the respective heat exchanger 4b, 4c may be provided with a plurality of fins 30 for air cooling of the heat exchanger 4b, 4c. As can be seen in FIGS. 5 and 6, the fins 30 may suitably be provided on a side of the heat exchanger which is opposite to a side that contacts the at least one planar exterior wall portion of the hydrogen tank 2. The fins 30 on the upper side 26 of the heat exchanger 2 in FIG. 6, may similarly to FIG. 4 be used as a platform, e.g., when connecting/disconnecting a trailer vehicle.

FIG. 7 schematically illustrates that according to at least one exemplary embodiment of a cooling arrangement 1d of the present disclosure, the hydrogen tank 2 is cuboid and the metal part of the heat exchanger 4d covers all six sides of the hydrogen tank 2 to form metal-to-metal contact on all six sides thereof. It should be noted that since this is a schematic illustration of a cross-sectional view, the heat exchanger 4d can only be seen on four sides of the hydrogen tank 2. In at least some exemplary embodiments, the heat exchanger 4d may be provided with a plurality of fins, similarly to the embodiments illustrated in FIGS. 5 and 6.

1. A cooling arrangement for a fuel cell electric vehicle, comprising:
a hydrogen tank comprising a metal enveloping wall,
a heat exchanger comprising a metal part with at least one internal coolant channel for conducting a coolant to fuel cells of the vehicle,
wherein the metal enveloping wall of the hydrogen tank has at least one planar exterior wall portion, wherein the metal part of the heat exchanger is attached to said planar exterior wall portion of the hydrogen tank to form a planar metal-to-metal contact for transferring heat from the coolant, via the metal part of the heat exchanger, to the metal enveloping wall of the hydrogen tank.

2. The cooling arrangement according to claim 1, wherein the hydrogen tank has a rectangular cross-section.

3. The cooling arrangement according to claim 1, wherein the hydrogen tank is cuboid.

4. The cooling arrangement according to claim 1, wherein the hydrogen tank is configured to be mounted to the vehicle so that said planar exterior wall portion to which the metal part of the heat exchanger is attached defines a vertical plane.

5. The cooling arrangement according to claim 4, wherein the hydrogen tank has an inboard side configured to face towards the central longitudinal axis of the vehicle and an outboard side configured to face away from the central longitudinal axis of the vehicle, wherein said planar exterior wall portion is located on the outboard side, wherein the attached heat exchanger forms a collision protection structure for protecting the hydrogen tank.

6. The cooling arrangement according to claim 1, wherein the hydrogen tank is configured to be mounted to a vehicle so that said planar exterior wall portion to which the metal part of the heat exchanger is attached defines a horizontal plane.

7. The cooling arrangement according to claim 6, wherein the hydrogen tank has a lower side configured to face towards the ground on which the vehicle stands and an upper side configured to face away from the ground, wherein said planar exterior wall portion is located on the upper side, wherein the attached heat exchanger forms a walking platform enabling a person to stand on the heat exchanger without touching the hydrogen tank.

8. The cooling arrangement according to claim 1, wherein the metal enveloping wall of the heat exchanger has at least two planar exterior wall portions which extend perpendicularly to each other, wherein the metal part of the heat exchanger has an L-shaped cross-section such that metal-to-metal contact is formed with both of said two planar exterior wall portions.

9. The cooling arrangement according to claim 1, wherein the heat exchanger is provided with a plurality of fins for air cooling of the heat exchanger.

10. The cooling arrangement according to claim 9, wherein the fins are provided on a side of the heat exchanger which is opposite to the side that contacts the planar exterior wall portion of the hydrogen tank.

11. The cooling arrangement according to claim 1, wherein the hydrogen tank is cuboid and the metal part of the heat exchanger covers all six sides of the hydrogen tank to form metal-to-metal contact on all six sides thereof.

12. A fuel cell electric vehicle comprising fuel cells and a cooling arrangement according to claim 1 for cooling said fuel cells.
